(19) United States
(12) Patent Application Publication
(10) Pub. No.: US 2025/0104482 A1
(43) Pub. Date: Mar. 27, 2025

(54) METHOD AND SYSTEM OF VIDEO PROCESSING FOR DETERMINING LIVENESS OF A SUBJECT

(71) Applicant: HYPERVERGE INC., Irving, TX (US)

(72) Inventors: Vignesh Krishnakumar, Chennai (IN); Hariprasad P S, Chennai (IN); R V N S Kalyan, Hyderabad (IN); Karthik Pullalarevu, Bangalore (IN); Yogeeshwar S, Chromepet (IN)

(73) Assignee: HYPERVERGE INC., Irving, TX (US)

(21) Appl. No.: 18/891,866

(22) Filed: Sep. 20, 2024

Related U.S. Application Data
(60) Provisional application No. 63/584,825, filed on Sep. 22, 2023.

(51) Int. Cl. G06V 40/40; G06V 10/32; G06V 10/75; G06V 20/40; G06V 40/16

(52) U.S. Cl. CPC G06V 40/40; G06V 10/32; G06V 10/75; G06V 20/40; G06V 40/161

(57) ABSTRACT

The present disclosure relates to a method and a system of video processing for determining liveness of a subject. The method comprises capturing a plurality of multi-media frames related to a video. The method further comprises sampling a plurality of consecutive frames from the plurality of multi-media frames. The method further comprises generating a set of optic flow images based on the plurality of consecutive frames. The method further comprises providing to a multi-branch video liveness model, a sub-set of the plurality of consecutive frames and the set of optic flow images. The method further comprises generating, by the multi-branch video liveness model, a video liveness score based on a processing of the sub-set of the plurality of consecutive frames and the set of optic flow images. The method further comprises determining the liveness of the subject based on the video liveness score.

### CROSS REFERENCE TO RELATED APPLICATION

This application claims the benefit under 35 U.S.C. § 119 (e) of U.S. Provisional Patent Application No. 63/584,825, filed Sep. 22, 2023, the entire contents of which are incorporated herein by reference.

### FIELD OF THE INVENTION

The present disclosure generally relates to biometric authentication-based liveness detection. More particularly, the present disclosure relates to a method and a system of video processing for determining liveness of a subject.

### BACKGROUND OF THE DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as an admission of prior art.

As the world becomes increasingly interconnected and reliant on digital platforms, the specter of identity fraud looms ever larger. Identity fraud poses a significant threat to individuals, businesses, and governments alike, leading to financial losses, compromised security, and reputational damage. Therefore, there is a pressing need for advanced measures to combat this growing menace. One essential solution lies in the development and implementation of robust liveness detection systems. These systems are designed to differentiate between real human beings and sophisticated impersonation attempts using artificial means like deepfakes, photoshop, digitally altered, synthetic images or other forged materials. By accurately verifying the genuine presence of a live person during identity verification processes, liveness detection ensures the authenticity and integrity of digital interactions, reinforcing trust, and safeguarding against fraudulent activities. As technology continues to evolve, the adoption of a resilient liveness detection system becomes paramount in fortifying the digital landscape against the ever-evolving tactics employed by identity fraudsters.

Over the period, face recognition technology has become an essential part of modern security systems. However, there is a growing concern over the vulnerability of such systems to spoofing attacks. Spoofing attacks refer to attempts by an impostor to impersonate a genuine user by presenting a fake or manipulated multiframe media (i.e., video) to the system. To counter such attacks, several anti-spoofing systems have been developed, falling under two categories: active and passive liveness solutions. Active liveness solutions require the subject to perform a pre determined activity or any random motion. These solutions rely on the action performed by the subject to determine the liveness of the subject such as user. For example, an active liveness system may ask the subject to blink or nod their head. Passive liveness solutions, on the other hand, determine the liveness of the subject based on the input captured without expecting the subject to perform any sort of activity. Passive liveness systems are more desirable in real-world scenarios as they are easy to use and reduce user inconvenience.

Further, the known existing active liveness solutions require the subjects to carry out a complex and elaborate set of tasks, affecting the system's overall usability and making it difficult to be carried out for someone inexperienced with the procedure. Therefore, there is a need for more accessible and user-friendly passive liveness solutions. The most of the existing passive liveness solutions rely on depth information from stereovision cameras, infra-red readings from an IR sensor, photoplethysmography sensor, etc. Dependency on such sensors results in hardware constraints and would require a custom hardware setup for the system to be used. Such systems, therefore, cannot be implemented in a wide variety of day-to-day life electronic devices such as mobile phones, tablets etc. However, passive liveness systems relying on multiframe media information from cameras, can be more accessible and easily consumed in the form of mobile or web applications. Further, few of the known approaches use only a specific portion of information from the captured multiframe media, such as corneal reflection, reflection from artificially induced illumination patterns, etc. This can cause such systems to be sensitive and less robust to the environment where the input is captured. Several external factors, such as the background of the subject illumination conditions, can affect the performance of the liveness detection system. Further, several existing approaches use a face detection module to crop out the face region from the multiframe media and only use the specific face region to analyze the liveness. In the case of certain non-live attacks, such as presentation attacks on different display devices, print attacks, and mask-based attacks, apparent clues such as reflection, random text, borders, etc. will be lost if only the face region is used.

Therefore, there are a number of limitations to the existing solutions and in order to overcome these and such other limitations of the known solutions it is necessary to provide an efficient solution for video (i.e., multiframe media) processing-based liveness detection.

### SUMMARY

This section is provided to introduce certain aspects of the present disclosure in a simplified form that are further described below in the detailed description. This summary is not intended to identify the key features or the scope of the claimed subject matter.

An aspect of the present disclosure may relate to a method of video processing for determining a liveness of a subject. The method comprises capturing, by a capturing unit, a plurality of multi-media frames related to a video. The method further comprises sampling, by a sampling unit, a plurality of consecutive frames from the plurality of multi-media frames. The method further comprises generating, by a generation unit, a set of optic flow images based on the plurality of consecutive frames. The method further comprises providing, by an input unit to a multi-branch video liveness model, a sub-set of the plurality of consecutive frames and the set of optic flow images. The method further comprises generating, by the multi-branch video liveness model, a video liveness score based on a processing of the sub-set of the plurality of consecutive frames and the set of optic flow images. The method further comprises determining, by a determination unit, the liveness of the subject based on the video liveness score.

An aspect of the present disclosure may relate to a system of video processing for determining a liveness of a subject. The system comprising a capturing unit configured to capture, a plurality of multi-media frames related to a video. The system further comprises a sampling unit configured to sample, a plurality of consecutive frames from the plurality of multi-media frames. The system further comprises a generation unit configured to generate a set of optic flow images based on the plurality of consecutive frames. The system further comprises an input unit configured to provide, to a multi-branch video liveness model, a sub-set of the plurality of consecutive frames and the set of optic flow images. The multi-branch video liveness model is then configured to generate, a video liveness score based on a processing of the sub-set of the plurality of consecutive frames and the set of optic flow images. The system further comprises a determination unit configured to determine the liveness of the subject based on the video liveness score.

### OBJECTS OF THE DISCLOSURE

This section is provided to introduce certain non-limiting objects of the present disclosure.

In order to overcome at least a few problems associated with the known solutions as provided in the previous section, an object of the present invention is to substantially reduce the limitations and drawbacks of the prior arts as described hereinabove.

An object of the present disclosure is to provide a solution for video processing for determining liveness of a subject to efficiently detect a fraudulent action.

Another object of the present disclosure is to provide a truly passive video processing-based liveness detection system that can be used on any device with a camera, such as mobile devices, computers, and edge devices, making it accessible and user-friendly for a broad range of users.

Yet another object of the present disclosure is to provide a solution that uses multiframe media or videos to determine liveness, resulting in a more robust and accurate detection system.

Yet another object of the present disclosure is to provide a solution for an easy-to-integrate SDK for input capture for liveness detection that further allows the existing developers to integrate the solution into their existing applications.

Yet another object of the present disclosure is to provide a solution that is compatible with a mobile or web application, providing a user-friendly interface for end-users to interact with the video processing-based liveness detection system.

### BRIEF DESCRIPTION OF DRAWINGS

The accompanying drawings, which are incorporated herein, constitute a part of this disclosure. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components or circuitry commonly used to implement such components. Although exemplary connections between sub-components have been shown in the accompanying drawings, it will be appreciated by those skilled in the art that other connections may also be possible, without departing from the scope of the invention. All sub-components within a component may be connected to each other, unless otherwise indicated.

FIG. 1 illustrates an exemplary system of video processing for determining liveness of a subject, in accordance with exemplary embodiments of the present invention.

FIG. 2 illustrates an exemplary method of video processing for determining liveness of a subject, in accordance with exemplary embodiments of the present invention.

The foregoing shall be more apparent from a more detailed description of the invention below.

### DETAILED DESCRIPTION OF THE DISCLOSURE

In the following description, for the purposes of explanation, various specific details are set forth in order to provide a thorough understanding of the embodiments of the present invention. It will be apparent, however, that embodiments of the present invention may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present invention are described below, as illustrated in various drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

Specific details are given in the following description to provide a thorough understanding of the embodiments. However, it will be understood by one of ordinary skills in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

A “processor” or “processing unit” refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required to perform the functions as disclosed in the present disclosure.

The present invention relates to methods and systems for video processing for determining liveness of a subject. The subject may be a person whose identity is required to be verified in various use cases such as while applying any application for banking purpose etc. The solution as disclosed in the present disclosure encompasses capturing a plurality of multi-media frames related to a video. Thereafter, a plurality of consecutive frames from the plurality of multi-media frames are sampled. For instance, the plurality of consecutive frames may include seventeen consecutive multi-media frames from the plurality of multi-media frames.

Further, in the present solution, a set of optic flow images is generated utilizing the plurality of consecutive frames. Considering the above instance where the plurality of consecutive frames includes seventeen consecutive multi-media frames, the set of optic flow images comprises sixteen optic flow images. Also, each optic flow image from said sixteen optic flow images is generated by creating a pair of two consecutive frames from the plurality of consecutive frames (i.e., the seventeen consecutive multi-media frames), and by running the created pair on an optic flow model.

Thereafter, a sub-set of the plurality of consecutive frames and the set of optic flow images are provided to a multi-branch video liveness model. The sub-set of the plurality of consecutive frames comprises last “n” number of frames from the plurality of consecutive frames. Also, considering the above instance where the plurality of consecutive frames comprises seventeen consecutive multi-media frames, the last “n” number of frames are last sixteen consecutive frames. Further, the multi-branch video liveness model is trained to detect a movement of a target subject in a target video in an event of one of presence of a set of non-live attacks in said target video and an absence of the set of non-live attacks in said target video. The set of non-live attacks comprises at least one of one or more display attacks, one or more print attacks, and one or more mask-based attacks.

Also, the multi-branch video liveness model is further trained to generate a target video liveness score based on the movement of the target subject in the target video.

Further, once the sub-set of the plurality of consecutive frames and the set of optic flow images are provided to the multi-branch video liveness model, the multi-branch video liveness model then generates a video liveness score based on a processing of the sub-set of the plurality of consecutive frames and the set of optic flow images. Thereafter, the liveness of the subject is determined based on the video liveness score. The liveness of the subject is determined based on a comparison of the video liveness score with a pre-specified threshold score.

Therefore, the present disclosure provides an efficient and effective solution of video processing for determining liveness of the subject. The present disclosure overcomes the problem(s) associated with the known solutions by providing a solution for video processing-based liveness detection that efficiently detects a fraudulent action. Also, the present solution provides a truly passive video processing-based liveness detection system to efficiently detect a fraudulent action. Additionally, the present solution provides a video processing based passive liveness detection system that can be used on any device with a camera, such as mobile devices, computers, and edge devices, making it accessible and user-friendly for a broad range of users. Furthermore, the present disclosure provides a solution that uses a video-based data, to determine liveness, resulting in a more robust and accurate detection system. The solution as provided in the present disclosure provides an easy-to-integrate SDK for input capture for liveness detection that further allows the existing developers to integrate the solution into their existing applications. Moreover, the present disclosure provides a solution that is compatible with a mobile or web application, providing a user-friendly interface for end-users to interact with the liveness detection system. Therefore, the present disclosure provides a solution that is technically advanced than the existing solution for liveness detection of the subject.

The present disclosure is further explained in detail below with reference now to the diagrams.

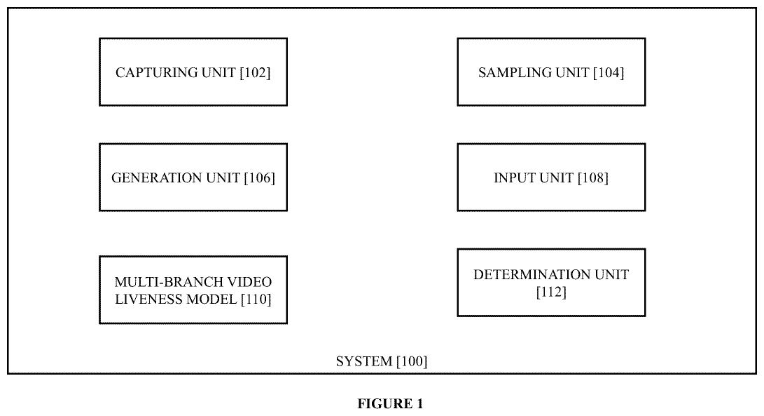

Referring now to FIG. 1, an exemplary system diagram [100] for video processing for determining liveness of a subject, in accordance with exemplary embodiments of the present invention is shown. The system encompasses at least one capturing unit [102], at least one sampling unit [104], at least one generation unit [106], and at least one input unit [108], at least one multi-branch video liveness model [110], and at least one determination unit [112]. All of these components/units of the system are assumed to be connected to each other unless otherwise indicated below and working in conjunction to achieve the objectives of the present invention. While only a few exemplary units are shown in FIG. 1, it may be understood that the system [100] may comprise multiple such units or the system [100] may comprise any such number of the units performing said functionalities, obvious to a person skilled in the art or as required to implement the features of the present disclosure.

In an implementation, to perform the functions as disclosed in the present disclosure, the system [100] may be configured at a user device (e.g., a smartphone), or the system [100] may be in communication with the user device, or the system [100] may be in communication with a standalone device (such as a specialized device that may be obvious to a person skilled in the art to implement the features as disclosed in the present disclosure). Also, in another implementation the system [100] may be configured partially or as a whole at a server end, wherein one or more servers at the server end may be in communication with one or more user devices to implement the features of the present disclosure.

The system [100] is configured to process a video for determining liveness of a subject captured in the video, with the help of the interconnection between its components/units.

Initially to perform the video processing for determining liveness of the subject, the capturing unit [102] is configured to capture a plurality of multi-media frames related to a video of the subject. The subject may be a person or a user whose identity is required to be verified in various use cases such as in an event where a user is required to capture his video for identity verification purposes. Further, for capturing the video, at least one of a set of compliance checks and a set of sanity checks are performed. In an implementation the capturing unit [102] initially captures the plurality of multi-media frames from an electronic device such as a mobile phone, a computer, a tablet etc. connected to the system [100]. In such implementation a capture screen to a user of the user device or the electronic device is presented to capture a video of the user, wherein the capture screen includes a capture button and an area where a camera feed is displayed.

Also, in a preferred implementation of the present solution, the captured camera feed is processed by a face detector unit which may be a lightweight face detector to detect one or more faces in the camera feed. It would be appreciated by a person skilled in the art that the face detector unit is not limited to the lightweight face detector, and another type of the face detector unit may be considered depending on a use case. In another implementation of the present disclosure, the capture button is enabled only in a scenario where at least one face of an appropriate size is detected at the capture screen presented to the user. Further, in a scenario where at least one face of the appropriate size is detected, the capture button is enabled and a camera feed of the user is captured, wherein the camera feed of the user comprises one or more frames comprising an image of the user, and one or more previous frames associated with the image of the user.

In an exemplary implementation of the present solution, the one or more previous frames associated with the image of the user may comprise a set of frames up to 1 second prior to the frame associated with the image of the user, for e.g., if frame associated with the image of the user is captured at time=T3 then the one or more previous frames may comprise set of frames up to 1 1 second prior to the frame associated with the image of the user that is the set of frames between T1 and T3-1 sec based on the camera feed. In another exemplary implementation of the present solution, the one or more previous frames associated with the image of the user may comprise the set frame that is at least 3 second prior to the frame associated with the image of the user. It is to be noted that time for capturing the one or more previous frames as disclosed herein may be either a preconfigured time or a dynamically defined time, as may deem appropriate for the implementation of the present solution. It should also be noted that the specific exemplary implementations mentioned, wherein the one or more previous frames associated with the image of the user are described as being at least 1 second or 3 seconds prior to the frame associated with the image of the user, are provided solely for illustrative purposes. These examples are not intended to limit the scope of the invention in any way. The invention encompasses various time intervals for capturing previous frames, and the embodiments mentioned are not exhaustive.

Furthermore, in an exemplary implementation of the present solution, a compliance check such as an orientation check associated with the electronic device/the user device may be performed in order to ensure it is held vertically with respect to the user before the capture button is enabled in order to facilitate capturing a camera feed via the electronic device. In an implementation of the present solution, the user may be presented with a preview screen to review the camera feed of the user. In a preferred implementation of the present solution, one or more frame checks and one or more heuristic checks may be performed on the camera feed of the user. In an implementation of the present invention, at least one of the one or more frame checks and the one or more heuristic checks is performed on the camera feed of the user to detect any subtle differences in consecutive frames of the camera feed of the user and to thereby detect any attempts of image injection in the camera feed of the user. In an exemplary implementation of the present solution, the camera feed of the user may be further processed to determine the liveness of the user, and to perform an end-to-end user signature verification and an end-to-end user signature encryption to prevent any fraudulent attack such as a man-in-the-middle attacks, and also to ensure the integrity of the input captured (i.e., captured video).

It is to be noted that the one or more sanity checks on one or more previous frames associated with the multiframe media (i.e., the video) of the user may include but not limited to a concurrent execution of a camera feed that is related to the one or more previous frames by one or more units to facilitate video capturing, a sequential execution of said camera feed by a specialized unit to facilitate the video capturing, or any other method that may be apparent to a person skilled in the relevant field. The disclosure of the solution herein, which encompasses performing one or more sanity checks on said camera feed of the user, should not be construed as imposing restrictions on the manner in which these sanity checks are performed.

Furthermore, in another implementation of the present solution, the one or more sanity checks on the camera feed of the user may also encompasses one or more image manipulation checks performed via one or more convolution network-based models on the multiframe media of the user to detect at least a face occlusion and an image manipulation. Further in an implementation of the present solution, to detect at least the face occlusion, the multiframe media of the user may be passed through a convolutional network-based occlusion detection module, as the face of the user may be occluded for e.g., with hands or other objects and hence the multiframe media of the user in such scenario may not be optimal to determine the liveness of the user. Thus, the occlusion check ensures that the face of the user is visible and consistent in all corresponding frames of the multiframe media of the user. Further, in an event the face is occluded, the input is rejected, and the user may be asked to retake the input.

Furthermore, in another implementation of the present solution, the one or more frames from the multiframe media of the user may be checked based on the one or more image manipulation checks performed via one or more convolution network-based modules for an image manipulation, such as photoshop edits or deep fakes. The multiframe media of the user captured may be passed through a convolution network-based based deep fake classifier and image manipulation detectors in order to perform the one or more image manipulation checks such as to detect any image manipulation(s) for e.g., a photoshop edit manipulation or a deep fake manipulation. Further, the one or more image manipulation checks may also be configured to successfully detect and reject the multiframe media submitted through camera feed hijacking.

Next, the sampling unit [104] is configured for sampling the plurality of consecutive frames from the plurality of multi-media frames. In an implementation the plurality of consecutive frames comprises seventeen consecutive multi-media frames from the plurality of multi-media frames. It would be appreciated by a person skilled in the art that a number of frames in the plurality of consecutive frames is not limited to seventeen, and its value may be varied depending on a use case.

Thereafter, the generation unit [106] is configured to generate a set of optic flow images based on the plurality of consecutive frames. Considering the above implementation where the plurality of consecutive frames comprises seventeen consecutive multi-media frames, the set of optic flow images comprises sixteen optic flow images. It would be appreciated by a person skilled in the art that a number of the set of optic flow images is not limited to sixteen, and its value may be varied depending on a use case. Furthermore, each optic flow image is generated by creating a pair of two consecutive frames from the plurality of consecutive frames, and by running the created pair on an optic flow model. For instance, in the above implementation each optic flow image from said sixteen optic flow images is generated by creating a pair of two consecutive frames from the plurality of consecutive frames comprising the seventeen consecutive multi-media frames, and by running the created pair on the optic flow model.

As used herein “the optical flow model” is a computer vision technique that estimates motion of objects (i.e., subject) in a video sequence. It involves analyzing the changes in intensity patterns of pixels over time to determine the direction and magnitude of object motion (i.e., motion of the subject). It is pertinent to note that optical flow can be used in various applications such as video stabilization, object tracking, and action recognition. In general, the optical flow model works by assuming that the movement of an object can be represented as a dense vector field, where each vector represents the displacement of a pixel from one frame to the next. The optical flow technique estimates this vector field by computing the displacement of pixels between adjacent frames. The present solution encompasses using a convolutional neural network to directly estimate the optical flow field from the input video frames. So, considering the above implementation where there are sixteen pairs of two consecutive frames, said sixteen pairs are passed through the optic flow model and corresponding sixteen optic flow frames (i.e., said sixteen optic flow images) are generated. Now in this implementation there are two sets of sixteen frames (one is the RGB frames, and the other is the optic flow frames).

Furthermore, the input unit [108] provides a sub-set of the plurality of consecutive frames and the set of optic flow images to a multi-branch video liveness model [110]. The sub-set of the plurality of consecutive frames comprises the last “n” number of frames from the plurality of consecutive frames. In the above-mentioned implementation where the plurality of consecutive frames comprises seventeen consecutive multi-media frames from the plurality of multi-media frames, the last “n” number of frames are last sixteen consecutive frames. It would be appreciated by a person skilled in the art that the last “n” number of frames is not limited to sixteen, and any value of “n” may be considered depending on a use case. Furthermore, the sub-set of the plurality of consecutive frames are related to the set of optic flow images. For instance, considering the above implementation, where the set of optic flow images comprises sixteen optic flow images, the sub-set of the plurality of consecutive frames will comprise the last sixteen consecutive frames. Therefore, in this implementation there are two sets of sixteen frames (one is the RGB frames, and the other is the optic flow frames) that are provided to the multi-branch video liveness model [110].

Also, prior to providing by the input unit to the multi-branch video liveness model [110], the sub-set of the plurality of consecutive frames and the set of optic flow images are resized in a pre-defined size e.g., 224×224. It would be appreciated by a person skilled in the art that the pre-defined size is not limited to 224×224, and any size may be considered depending on a use case.

Furthermore, the sub-set of the plurality of consecutive frames is provided as an input to a first branch of the multi-branch video liveness model [110], and the set of optic flow images is provided as an input to a second branch of the multi-branch video liveness model [110]. Therefore, in the above implementation, the sixteen consecutive RGB images are used as input for the first branch of the multi-branch video liveness model [110], while their corresponding optic flow images are used as an input for the second branch of the multi-branch video liveness model [110].

The multi-branch video liveness model [110] thereafter generates a video liveness score based on a processing of the sub-set of the plurality of consecutive frames and the set of optic flow images. More specifically, for generating the video liveness score, the multi-branch video liveness model [110] is trained to detect a movement of a target subject in a target video in an event of one of presence of a set of non-live attacks in said target video and an absence of the set of non-live attacks in said target video. The set of non-live attacks comprises at least one of one or more display attacks, one or more print attacks, and one or more mask-based attacks. A person skilled in the art would appreciate that the set of non-live attacks as mentioned herein is not limited and any include other such similar type of attacks. Also, as used herein the term “display attack” refers to a type of digital attack where a display configuration is tweaked with an intention of a display fraud. Also, as used herein the term “print attack” refers to a digital attack where a configuration of an image is tweaked with intention of a print related fraud. Additionally, as used herein the term “mask attack” refers to a type of digital attack where a configuration of an image is masked with an intention of a masking related fraud. Further, the processing of the sub-set of the plurality of consecutive frames and the set of optic flow images comprises detecting a movement of the subject in the video. Further, the multi-branch video liveness model [110] is further trained to generate a target video liveness score based on the movement of the target subject in the target video. Therefore, the multi-branch video liveness model [110] initially processes the sub-set of the plurality of consecutive frames and the set of optic flow images to determine a movement of the subject based on the presence and/or absence of one or more non-live attacks. Once the movement of the subject is determined then the multi-branch video liveness model [110] generates a liveness score based on such determined movement. The generated liveness score indicates the liveness or the non-liveness of the subject, where the non-liveness of the subject indicates a fraudulent action on the video received for identification of the subject. Therefore, the determination unit [112] is configured to determine the liveness of the subject based on the video liveness score.

In an implementation, the liveness of the subject may be determined based on a comparison of the video liveness score with a pre-specified threshold score. For instance, for a video received for an identification of the subject, if the video liveness score meets the criteria of the pre-specified threshold score, the liveness of the subject in corresponding video is validated, else the subject in said video is considered as non-live which further indicates a fraudulent action on the video.

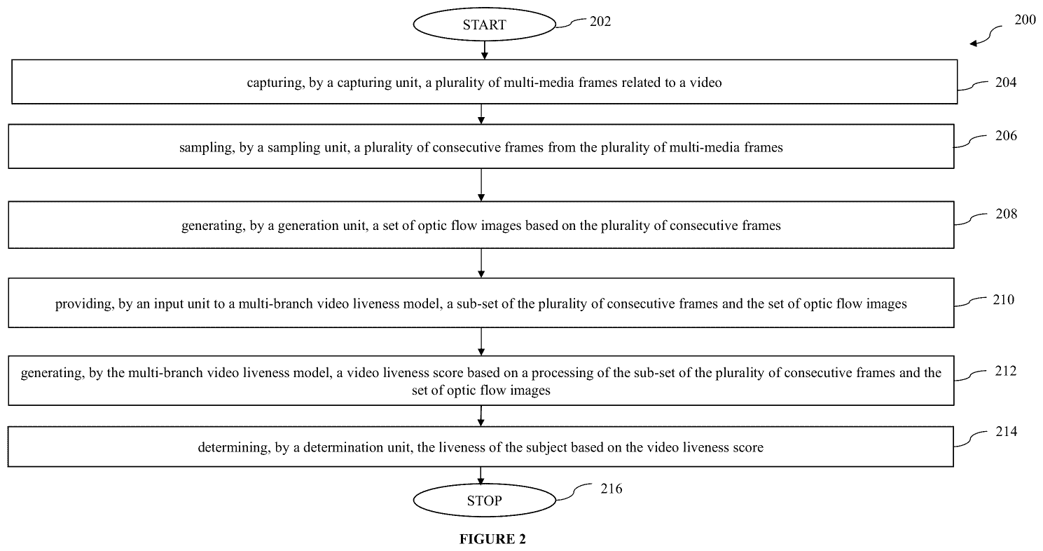

Referring to FIG. 2 that illustrates an exemplary method of video processing for determining liveness of a subject, in accordance with exemplary embodiments of the present invention. In an implementation, the method [200] is performed by the system [100]. As shown in FIG. 2, the method [200] begins at step [202]. In an implementation the method [200] may begin upon receiving a request for authentication or verification of a person via video processing.

In an event the method [200] may be implemented at a user device connected to the system [100], and an authentication or verification request may be received from an application such as a banking application, etc. at the system [100], to execute the method [200].

Next, at step [204], the method [200] comprises capturing, by the capturing unit [102], a plurality of multi-media frames related to a video of the subject. The subject may be a person or a user whose identity is required to be verified in various use cases such as in an event where a user is required to capture his video for identity verification purposes. Further, for capturing the video the method comprises performing at least one of a set of compliance checks and a set of sanity checks.

In an implementation the capturing unit [102] initially captures the plurality of multi-media frames from an electronic device such as a mobile phone, a computer, a tablet etc. connected to the system [100]. In such implementation a capture screen to a user of the user device or the electronic device is presented to capture a video of the user, wherein the capture screen includes a capture button and an area where a camera feed is displayed.

Also, in a preferred implementation of the present solution, the captured camera feed is processed by a face detector unit which may be a lightweight face detector to detect one or more faces in the camera feed. It would be appreciated by a person skilled in the art that the face detector unit is not limited to the lightweight face detector, and another type of the face detector unit may be considered depending on a use case. In another implementation of the present disclosure, the capture button is enabled only in a scenario where at least one face of an appropriate size is detected at the capture screen presented to the user. Further, in a scenario where at least one face of the appropriate size is detected, the capture button is enabled and a camera feed of the user is captured, wherein the camera feed of the user comprises one or more frames comprising an image of the user, and one or more previous frames associated with the image of the user.

In an exemplary implementation of the present solution, the one or more previous frames associated with the image of the user may comprise a set of frames up to 1 second prior to the frame associated with the image of the user, for e.g., if frame associated with the image of the user is captured at time, T3 then the one or more previous frames may comprise set of frames up to 1 1 second prior to the frame associated with the image of the user that is the set of frames between T1 and T3-1 sec based on the camera feed. In another exemplary implementation of the present solution, the one or more previous frames associated with the image of the user may comprise the set frame that is at least 3 seconds prior to the frame associated with the image of the user. It is to be noted that time for capturing the one or more previous frames as disclosed herein may be either a preconfigured time or a dynamically defined time, as may deem appropriate for the implementation of the present solution. It should also be noted that the specific exemplary implementations mentioned, wherein the one or more previous frames associated with the image of the user are described as being at least 1 second or 3 seconds prior to the frame associated with the image of the user, are provided solely for illustrative purposes. These examples are not intended to limit the scope of the invention in any way. The invention encompasses various time intervals for capturing previous frames, and the embodiments mentioned are not exhaustive.

Furthermore, in an exemplary implementation of the present solution, a compliance check such as an orientation check associated with the electronic device/the user device may be performed in order to ensure it is held vertically with respect to the user before the capture button is enabled in order to facilitate capturing a camera feed via the electronic device. In an implementation of the present solution, the user may be presented with a preview screen to review the camera feed of the user. In a preferred implementation of the present solution, one or more frame checks and one or more heuristic checks may be performed on the camera feed of the user. In an implementation of the present invention, at least one of the one or more frame checks and the one or more heuristic checks is performed on the camera feed of the user to detect any subtle differences in consecutive frames of the camera feed of the user and to thereby detect any attempts of image injection in the camera feed of the user. In an exemplary implementation of the present solution, the camera feed of the user may be further processed to determine the liveness of the user, and to perform an end-to-end user signature verification and an end-to-end user signature encryption to prevent any fraudulent attack such as a man-in-the-middle attacks, and to ensure the integrity of the input captured (i.e., captured video).

It is to be noted that the one or more sanity checks on one or more previous frames associated with the multiframe media (i.e., the video) of the user may include but not limited to a concurrent execution of a camera feed that is related to the one or more previous frames by one or more units to facilitate video capturing, a sequential execution of said camera feed by a specialized unit to facilitate the video capturing, or any other method that may be apparent to a person skilled in the relevant field. The disclosure of the solution herein, which encompasses performing one or more sanity checks on said camera feed of the user, should not be construed as imposing restrictions on the manner in which these sanity checks are performed.

Furthermore, in another implementation of the present solution, the one or more sanity checks on the camera feed of the user may also encompasses one or more image manipulation checks performed via one or more convolution network-based models on the multiframe media (i.e., the video) of the user to detect at least a face occlusion and an image manipulation. Further in an implementation of the present solution, to detect at least the face occlusion, the multiframe media of the user may be passed through a convolutional network-based occlusion detection module, as the face of the user may be occluded for e.g., with hands or other objects and hence the multiframe media of the user in such scenario may not be optimal to determine the liveness of the user. Thus, the occlusion check ensures that the face of the user is visible and consistent in all corresponding frames of the multiframe media of the user. Further, in an event the face is occluded, the input is rejected, and the user may be asked to retake the input.

Furthermore, in another implementation of the present solution, the one or more frames from the multiframe media of the user may be checked based on the one or more image manipulation checks performed via one or more convolution network-based modules for an image manipulation, such as photoshop edits or deep fakes. The multiframe media of the user captured may be passed through a convolution network-based based deep fake classifier and image manipulation detectors in order to perform the one or more image manipulation checks such as to detect any image manipulation(s) for e.g., a photoshop edit manipulation or a deep fake manipulation. Further, the one or more image manipulation checks may also be configured to successfully detect and reject the multiframe media submitted through camera feed hijacking.

Next, at step [206], the method [200] comprises sampling, by the sampling unit [104], a plurality of consecutive frames from the plurality of multi-media frames. In an implementation the plurality of consecutive frames comprises seventeen consecutive multi-media frames from the plurality of multi-media frames. It would be appreciated by a person skilled in the art that a number of frames in the plurality of consecutive frames is not limited to seventeen, and its value may be varied depending on a use case.

Next, at step [208], the method [200] comprises generating, by the generation unit [106], a set of optic flow images based on the plurality of consecutive frames. Considering the above implementation where the plurality of consecutive frames comprises seventeen consecutive multi-media frames, the set of optic flow images comprises sixteen optic flow images. It would be appreciated by a person skilled in the art that a number of the set of optic flow images is not limited to sixteen, and its value may be varied depending on a use case. Furthermore, each optic flow image is generated by creating a pair of two consecutive frames from the plurality of consecutive frames, and by running the created pair on an optic flow model. For instance, in the above implementation, each optic flow image from said sixteen optic flow images is generated by creating a pair of two consecutive frames from the plurality of consecutive frames comprising the seventeen consecutive multi-media frames, and by running the created pair on the optic flow model.

As used herein “the optical flow model” is a computer vision technique that estimates motion of objects (i.e., subject) in a video sequence. It involves analyzing the changes in intensity patterns of pixels over time to determine the direction and magnitude of object motion (i.e., motion of the subject). It is pertinent to note that optical flow can be used in various applications such as video stabilization, object tracking, and action recognition. In general, the optical flow model works by assuming that the movement of an object can be represented as a dense vector field, where each vector represents the displacement of a pixel from one frame to the next. The optical flow technique estimates this vector field by computing the displacement of pixels between adjacent frames. The present solution encompasses using a convolutional neural network to directly estimate the optical flow field from the input video frames. So, considering the above implementation where there are sixteen pairs of two consecutive frames, said sixteen pairs are passed through the optic flow model and corresponding sixteen optic flow frames (i.e., said sixteen optic flow images) are generated. Now in this implementation there are two sets of sixteen frames (one is the RGB frames, and the other is the optic flow frames).

Next, at step [210], the method [200] comprises providing, by the input unit [108] to the multi-branch video liveness model [110], a sub-set of the plurality of consecutive frames and the set of optic flow images. The sub-set of the plurality of consecutive frames comprises the last “n” number of frames from the plurality of consecutive frames. In the above-mentioned implementation where the plurality of consecutive frames comprises seventeen consecutive multi-media frames from the plurality of multi-media frames, the last “n” number of frames are last sixteen consecutive frames. It would be appreciated by a person skilled in the art that the last “n” number of frames is not limited to sixteen, and any value of “n” may be considered depending on a use case. Furthermore, the sub-set of the plurality of consecutive frames are related to the set of optic flow images. For instance, considering the above implementation, where the set of optic flow images comprises sixteen optic flow images, the sub-set of the plurality of consecutive frames will comprise the last sixteen consecutive frames. Therefore, in this implementation there are two sets of sixteen frames (one is the RGB frames, and the other is the optic flow frames) that are provided to the multi-branch video liveness model [110].

Also, prior to providing by the input unit to the multi-branch video liveness model [110], the sub-set of the plurality of consecutive frames and the set of optic flow images are resized in a pre-defined size e.g., 224×224. It would be appreciated by a person skilled in the art that the pre-defined size is not limited to 224×224, and any size may be considered depending on a use case.

Furthermore, the sub-set of the plurality of consecutive frames is provided as an input to a first branch of the multi-branch video liveness model [110], and the set of optic flow images is provided as an input to a second branch of the multi-branch video liveness model [110]. Therefore, in the above implementation, the sixteen consecutive RGB images are used as input for the first branch of the multi-branch video liveness model [110], while their corresponding optic flow images are used as an input for the second branch of the multi-branch video liveness model [110].

Next, at step [212], the method [200] comprises generating, by the multi-branch video liveness model [110], a video liveness score based on a processing of the sub-set of the plurality of consecutive frames and the set of optic flow images. More specifically, for generating the video liveness score, the multi-branch video liveness model [110] is trained to detect a movement of a target subject in a target video in an event of one of presence of a set of non-live attacks in said target video and an absence of the set of non-live attacks in said target video. The set of non-live attacks comprises at least one of one or more display attacks, one or more print attacks, and one or more mask-based attacks. A person skilled in the art would appreciate that the set of non-live attacks as mentioned herein is not limited and any include other such similar type of attacks. Also, as used herein the term “display attack” refers to a type of digital attack where a display configuration is tweaked with an intention of a display fraud. Also, as used herein the term “print attack” refers to a digital attack where a configuration of an image is tweaked with intention of a print related fraud. Additionally, as used herein the term “mask attack” refers to a type of digital attack where a configuration of an image is masked with an intention of a masking related fraud. Further, the processing of the sub-set of the plurality of consecutive frames and the set of optic flow images comprises detecting a movement of the subject in the video. Further, the multi-branch video liveness model [110] is further trained to generate a target video liveness score based on the movement of the target subject in the target video. Therefore, the multi-branch video liveness model [110] initially processes the sub-set of the plurality of consecutive frames and the set of optic flow images to determine a movement of the subject based on the presence and/or absence of one or more non-live attacks. Once the movement of the subject is determined then the multi-branch video liveness model [110] generates a liveness score based on such determined movement. The generated liveness score indicates the liveness or the non-liveness the subject, where the non-liveness of the subject indicates a fraudulent action on the video received for identification of the subject. Therefore, at step [214], the method [200] comprises determining, by the determination unit [112], the liveness of the subject based on the video liveness score.

In an implementation, the liveness of the subject may be determined based on a comparison of the video liveness score with a pre-specified threshold score. For instance, for a video received for an identification of the subject, if the video liveness score meets the criteria of the pre-specified threshold score, the liveness of the subject in corresponding video is validated, else the subject in said video is considered as non-live which further indicates a fraudulent action on the video.

The method thereafter terminates at step [216] after determining the liveness of the subject.

Therefore, the present disclosure provides an efficient and effective solution of video processing for determining liveness of the subject. The present disclosure overcomes the problem(s) associated with the known solutions by providing a solution for video processing-based liveness detection that efficiently detects a fraudulent action. Also, the present solution provides a truly passive video processing-based liveness detection system to efficiently detect a fraudulent action. Additionally, the present solution provides a video processing based passive liveness detection system that can be used on any device with a camera, such as mobile devices, computers, and edge devices, making it accessible and user-friendly for a broad range of users. Furthermore, the present disclosure provides a solution that uses a video-based data, to determine liveness, resulting in a more robust and accurate detection system. The solution as provided in the present disclosure provides an easy-to-integrate SDK for input capture for liveness detection that further allows the existing developers to integrate the solution into their existing applications. Moreover, the present disclosure provides a solution that is compatible with a mobile or web application, providing a user-friendly interface for end-users to interact with the liveness detection system. Therefore, the present disclosure provides a solution that is technically advanced than the existing solution for liveness detection of the subject.

While the invention has been explained with respect to many examples, it will be appreciated by those skilled in the art that the invention is not restricted by these examples and many changes can be made to the embodiments disclosed herein without departing from the principles and scope of the present invention.

What is claimed is:

1. A method of video processing for determining liveness of a subject, the method comprising:
capturing, by a capturing unit, a plurality of multi-media frames related to a video;
sampling, by a sampling unit, a plurality of consecutive frames from the plurality of multi-media frames;
generating, by a generation unit, a set of optic flow images based on the plurality of consecutive frames;
providing, by an input unit to a multi-branch video liveness model, a sub-set of the plurality of consecutive frames and the set of optic flow images;
generating, by the multi-branch video liveness model, a video liveness score based on a processing of the sub-set of the plurality of consecutive frames and the set of optic flow images; and
determining, by a determination unit, the liveness of the subject based on the video liveness score.

2. The method as claimed in claim 1, wherein for capturing the video the method comprises performing at least one of a set of compliance checks and a set of sanity checks.

3. The method as claimed in claim 1, wherein the plurality of consecutive frames comprises seventeen consecutive multi-media frames from the plurality of multi-media frames.

4. The method as claimed in claim 1, wherein the set of optic flow images comprises sixteen optic flow images.

5. The method as claimed in claim 4, wherein each optic flow image from said sixteen optic flow images is generated by creating a pair of two consecutive frames from the plurality of consecutive frames, and by running the created pair on an optic flow model.

6. The method as claimed in claim 1, wherein prior to providing, by the input unit to the multi-branch video liveness model, the sub-set of the plurality of consecutive frames and the set of optic flow images are resized in a pre-defined size.

7. The method as claimed in claim 1, wherein the sub-set of the plurality of consecutive frames comprises last “n” number of frames from the plurality of consecutive frames.

8. The method as claimed in claim 7, wherein the last “n” number of frames are last sixteen consecutive frames in an event the plurality of consecutive frames comprises seventeen consecutive multi-media frames from the plurality of multi-media frames.

9. The method as claimed in claim 1, wherein the set of optic flow images are related to the sub-set of the plurality of consecutive frames.

10. The method as claimed in claim 1, wherein the sub-set of the plurality of consecutive frames is provided as an input to a first branch of the multi-branch video liveness model, and the set of optic flow images is provided as an input to a second branch of the multi-branch video liveness model.

11. The method as claimed in claim 1, wherein the liveness of the subject is determined based on a comparison of the video liveness score with a pre-specified threshold score.

12. The method as claimed in claim 1, wherein the multi-branch video liveness model is trained to detect a movement of a target subject in a target video in an event of one of presence of a set of non-live attacks in said target video and an absence of the set of non-live attacks in said target video.

13. The method as claimed in claim 12, wherein the multi-branch video liveness model is further trained to generate a target video liveness score based on the movement of the target subject in the target video.

14. The method as claimed in claim 12, wherein the set of non-live attacks comprises at least one of one or more display attacks, one or more print attacks, and one or more mask-based attacks.

15. The method as claimed in claim 1, wherein the processing of the sub-set of the plurality of consecutive frames and the set of optic flow images comprises detecting a movement of the subject in the video.

16. A system of video processing for determining liveness of a subject, the system comprising:
a capturing unit, configured to capture, a plurality of multi-media frames related to a video;
a sampling unit, configured to sample, a plurality of consecutive frames from the plurality of multi-media frames;
a generation unit, configured to generate, a set of optic flow images based on the plurality of consecutive frames;
an input unit, configured to provide, to a multi-branch video liveness model, a sub-set of the plurality of consecutive frames and the set of optic flow images, wherein:
the multi-branch video liveness model is configured to generate a video liveness score based on a processing of the sub-set of the plurality of consecutive frames and the set of optic flow images; and
a determination unit, configured to determine, the liveness of the subject based on the video liveness score.

17. The system as claimed in claim 16, wherein for capturing the video at least one of a set of compliance checks and a set of sanity checks are performed.

18. The system as claimed in claim 16, wherein the plurality of consecutive frames comprises seventeen consecutive multi-media frames from the plurality of multi-media frames.

19. The system as claimed in claim 16, wherein the set of optic flow images comprises sixteen optic flow images.

20. The system as claimed in claim 19, wherein each optic flow image from said sixteen optic flow images is generated by creating a pair of two consecutive frames from the plurality of consecutive frames, and by running the created pair on an optic flow model.

21. The system as claimed in claim 16, wherein the sub-set of the plurality of consecutive frames and the set of optic flow images are resized in a pre-defined size prior to the input unit provides the sub-set of the plurality of consecutive frames and the set of optic flow images to the multi-branch video liveness model.

22. The system as claimed in claim 16, wherein the sub-set of the plurality of consecutive frames comprises last “n” number of frames from the plurality of consecutive frames.

23. The system as claimed in claim 22, wherein the last “n” number of frames are last sixteen consecutive frames in an event the plurality of consecutive frames comprises seventeen consecutive multi-media frames from the plurality of multi-media frames.

24. The system as claimed in claim 16, wherein the set of optic flow images are related to the sub-set of the plurality of consecutive frames.

25. The system as claimed in claim 16, wherein the sub-set of the plurality of consecutive frames is provided as an input to a first branch of the multi-branch video liveness model, and the set of optic flow images is provided as an input to a second branch of the multi-branch video liveness model.

26. The system as claimed in claim 16, wherein the liveness of the subject is determined based on a comparison of the video liveness score with a pre-specified threshold score.

27. The system as claimed in claim 16, wherein the multi-branch video liveness model is trained to detect a movement of a target subject in a target video in an event of one of presence of a set of non-live attacks in said target video and an absence of the set of non-live attacks in said target video.

28. The system as claimed in claim 27, wherein the multi-branch video liveness model is further trained to generate a target video liveness score based on the movement of the target subject in the target video.

29. The system as claimed in claim 27, wherein the set of non-live attacks comprises at least one of one or more display attacks, one or more print attacks, and one or more mask-based attacks.

30. The system as claimed in claim 16, wherein the processing of the sub-set of the plurality of consecutive frames and the set of optic flow images comprises detecting a movement of the subject in the video.
